(19) United States
(12) Patent Application Publication
(10) Pub. No.: US 2026/0228365 A1
(43) Pub. Date: Aug. 6, 2026

(54) METHOD AND SYSTEM FOR HANDLING AT LEAST ONE UNAUTHORISED ACCESS TO AT LEAST ONE SHARED RESOURCE BY AT LEAST ONE CONTAINER INSTANCE

(71) Applicant: Siemens Aktiengesellschaft, München (DE)

(72) Inventor: Christian Knierim, München (DE)

(21) Appl. No.: 19/151,165

(22) PCT Filed: Dec. 6, 2023
(86) PCT No.: PCT/EP2023/084492

§ 371 Date: Jul. 25, 2025

(30) Foreign Application Priority Data
Jan. 31, 2023 (EP) 23154229.1

(51) Int. Cl. G06F 21/62; G06F 9/455

(52) U.S. Cl. CPC G06F 21/629; G06F 9/45558; G06F 2009/45587; G06F 2221/2141

(57) ABSTRACT

A computer-implemented method for handling at least one unauthorised access to at least one shared resource by at least one first container instance is provided, wherein the at least one first container instance and at least one second container instance are executed in a shared runtime environment of a host system, wherein the at least one second container instance uses the at least one shared resource, the method including the following method steps: establishing and providing at least one access authorisation criterion for one of the second container instances, which governs which operations with access to the shared resource are authorised or unauthorised by the at least one first container instance: verifying, when a new first container instance is launched, whether at least one access authorisation criterion has been provided for the second container instance: in the case of a positive result, monitoring the operations of the first container instance during its execution as to whether these operations are unauthorised in accordance with the at least one access authorisation criterion: and if at least one operation is detected as unauthorised during the monitoring, then initiating handling that prevents access to the shared resource by sending an alarm message for the second container instance or by stopping the execution of the second container instance.

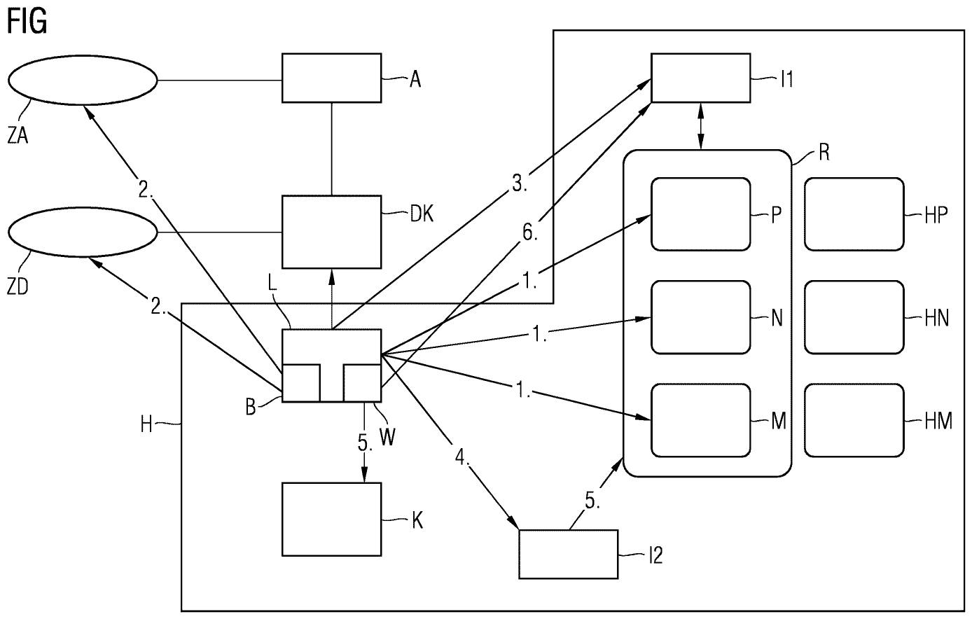

### CROSS-REFERENCE TO RELATED APPLICATIONS

This application is a national stage of PCT Application No. PCT/EP2023/084492, having a filing date of Dec. 6, 2023, which claims priority to EP Application No. 23154229.1, having a filing date of Jan. 31, 2023, the entire contents both of which are hereby incorporated by reference.

### FIELD OF TECHNOLOGY

The following relates to a method and to an arrangement, and also to associated devices and to an associated computer program product.

### BACKGROUND

Since industrial systems (controllers, industrial PCs, IoT and Edge devices, cloud servers) are often used over a long period in the field, they are subject to constantly changing requirements and a dynamic environment. To deal with these circumstances, new devices are developed primarily such that they are able to be adapted flexibly over their usage time, for example by being supported by downloadable applications or apps. Software containers, called containers below for short, are suitable for this purpose. Containers thus constitute a kind of virtualization of a runtime environment on a guest computer, also called a host system, and encapsulate an application running in a container from the underlying host system. Applications, also called apps, are in the meantime implemented by way of containers in a large number of fields, such as for example in industrial automation and in process control, but also for applications in transport systems or vehicles.

To be able to launch a container on the host system, there is a requirement for a container image that, in addition to an application program, also called application software, contains the binary programs and libraries required for the application program. The container image itself may consist of multiple layers that build on one another and that are able to be protected (cryptographically, memory-protected, etc.). A container image is normally portable, is able to be stored in repositories (also called a container registry) and shared with other users. A container instance, more simply a container, is created from the container image on the host system and executed on a (container) runtime environment, such as for example a “docker”. If necessary, for example in the event of increased calling of the application by users, further container instances may be generated from the same container image and run on the same or a different host system, which may also be in the form of virtualized hardware resources. The root file system of a container instance is formed from the layers of an image and a further volatile layer. In this case, multiple container instances are permitted (“as guests”) to use the operating system kernel (also called kernel) of a host system in isolation from one another. Hereinafter, the designations container instance and container will be used synonymously.

When the container instance is launched, the processes mentioned in the container instance are assigned execution permissions, also called privileges, and an agreement on device resources or other file system resources of the underlying device or system is also agreed. In order to avoid attacks by the application on the host system, these execution permissions may be restricted (=restriction), so that the container is assigned only the rights required to run the application. A containerized application usually does not consist of a single isolated container instance, but rather is provided, due to a microservice-based architecture, in conjunction with other container instances as an overall application. Interaction between multiple container instances or interaction between their virtual infrastructure, and in particular their runtime and process permissions, is defined inter alia in provisioning information, also called a deployment configuration. In the non-orchestrated range, a “docker-compose” format specified by a docker may for example be used for this purpose.

In this interaction between multiple container instances, it is particularly critical that different container instances executed in isolation share the same operating system kernel.

By virtue of container instances furnished with appropriate privileges, actions may be performed in other container instances. Actions may in this case be for example the tracing (tracking) of processes, the transmission of process signals (such as for example kill), the performance of write operations to file system ranges assigned to other instances or the launching of further processes in a container. The performance of such actions by such a container instance on another container instance is able to be prevented by the runtime environment only by permitting or restricting certain privileges when a container instance is launched by the runtime environment. It is necessary to prohibit certain runtime parameters in the configuration of the runtime environment. In the standard case, containers are not permitted to use the namespace of other containers. However, within the deployment configuration, it may be specified that one container instance is permitted to use the namespace of another container instance. Namespaces offer the option of making isolated ranges of the operating system kernel available for example for network connections, file system ranges or processes, and not all of the resources of the underlying system are visible to a process launched in a namespace. In containerization technology, the use of namespaces is an elementary part of the isolation of individual instances.

Insofar as a container instance is not able to make any assumption as to what restrictions are enforced on the platform, it is not able to assume per se that it is isolated sufficiently from other container instances and thus that no unauthorized reading or modification is performed by another container instance.

By way of example, in the exemplary application of Industrial Edge, described for example in https://new.siemens.com/de/de/produkte/automatisierung/themenfelder/industrial-edge.html, there is the option of various manufacturers being able to provide different apps, for example in an app store, which consist of multiple different containers and are installed on the device by the operator of the device, similarly to smartphone apps. Although the operator of the Edge platform is able to define security requirements in this environment, these may differ from application case to application case, meaning that an app or a first container instance running within an app is not informed as soon as a second/further container instance of another app accesses resources that have been provided for the app.

EP 21211418.5 already discloses a method for enforcing integrity conditions of a first container-based application in relation to all second container-based applications executed on a common runtime environment of a host system. This solution is based on the assumption that the required restrictions are enforced on the container runtime environment on the entire host system, and these restrictions also remain valid at runtime of the respective apps. Compliance with the guidelines defined by the application is checked only at deployment. No further check takes place at runtime, however. The containers running in an app to be protected are also not informed when containers of other apps access these container instances and for example monitor processes in their namespace, launch new processes or execute write operations. Furthermore, infringements of a guideline, also called a policy, are not handled on an application-specific or container instance-specific basis. If the requirements are not met, deployment of the application is denied.

Integrity monitoring systems such as Falco (https://falco.org) are known. Such a solution may be used to check integrity requirements placed on ego containers on the underlying host system using static rules. However, a Falco-based solution cannot be used to check whether for example the processes of the underlying host namespace are tracked by other, appropriately privileged containers or for example what are known as sidecar containers are launched, these modifying the network configuration of the container instance. A sidecar is another container that shares resources, such as for example a network namespace or the container file system. Furthermore, Falco provides only an alert outside the container but does not inform the container instance directly so that error handling (such as for example reinstallation of the configuration, suppression until recognition that permitted actions have been carried out) is able to be performed within the app or container instance.

The operator of the platform is thus able to be alerted, but the app developer, which creates the deployment configuration and the container images, does not define independent integrity requirements and create relevant operational actions derived therefrom at runtime.

### SUMMARY

An aspect relates to a method and a system in such a way as to ensure handling of at least one unauthorized access operation to one or more common resources by a container instance, which is executed in a runtime environment together with other container instances using the common resource and in which an application runs, which handling is improved compared to the prior art.

Embodiments of the invention claim a computer-implemented method for handling at least one unauthorized access operation to at least one common resource by at least one first container instance, wherein the at least one first container instance and at least one second container instance are executed on a common runtime environment of a host system, wherein the at least one second container instance uses the at least one common resource, comprising the following method steps:
defining and providing at least one access authorization criterion for one of the second container instances that rules which operations involving accessing of or an action on the common resource by the at least one first container instance are authorized or permitted or unauthorized or forbidden,
checking, when a new first container instance is launched, whether at least one access authorization criterion has been provided for the second container instance,
in the event of a positive check, monitoring the operations of the first container instance during execution thereof as to whether these operations are unauthorized in accordance with the at least one access authorization criterion, and
if, during monitoring, at least one operation is recognized as unauthorized, then initiating an action that counteracts or prevents the accessing of the common resource, by way of an alert message for the second container instance or by stopping the execution of the second container instance.

Stopping may in this case mean interrupting or terminating.

In the event of a negative check, the operations of the first container instance may be monitored and, if, from the point of view of the runtime environment, all operations accessing or acting on the common resources are considered to be unauthorized (deny by default), when such an operation considered to be unauthorized is executed, an action that counteracts or prevents the accessing of the common resource is initiated by way of an alert message for the second container instance or by stopping the execution of the second container instance.

Common resources are understood in this context to mean firstly a common namespace shared by multiple container instances. Common resources are also understood to mean a parent namespace used by a host system, from which multiple child namespaces are generated for multiple container instances when the respective container instances are launched, these namespaces being run independently for each container instance without one container instance sharing the respective child namespace with another container instance. Common resources may however also be file system objects, which are generally files or directories/folders, and device data. If such objects or files are in virtual form, then similar parent/child relationships apply as in the case of the namespaces. If these objects or files are in physical form, they are located on the host system. Multiple container instances may potentially access them via the runtime environment.

Container instances may thus be isolated from one another by virtue of them running their processes in separate namespaces. The namespace concept makes it possible to isolate networks, processes or mounted file systems. There are separate namespaces for the respective application case. In addition, namespaces generally have a hierarchical structure, such that, when a container is launched, child namespaces of the respective host namespace are generated. At launch, container instances may be run completely in their own namespaces or else run together in shared namespaces. It is not necessary here for all container instances to share all namespaces, but rather individual types of namespaces are also shared; for example only the network namespace. The latter is used in the case of what are known as sidecar containers, which for example realize a transparent proxy for a workload container. In the case of correspondingly privileged containers, it is additionally possible for these to be run in the host namespace and thus be run in the parent namespace of other container instances.

In other words, the other container instances, here the first ones, are monitored when they access the common resources of the container instance to be protected, here the second one, and at least one corresponding access authorization criterion is present.

The “foreign” container instance, here the launched first container instance, is accordingly not fended off in the event of unauthorized access, but rather the ego container instance, here the second container instance, is protected by way of an appropriate action or measure that it itself has to hand.

The at least one access authorization criterion may be present in a container image belonging to the second container instance and/or be able to be referenced in provisioning information (a deployment configuration), used by the runtime environment, concerning the execution of the at least one second container instance.

An authorization criterion may take a form such that operations are identified as permitted or as unauthorized/forbidden by way of an appropriate marker/label. The at least one authorization criterion, which may be in the form of a policy, may be integrity-protected, together with the deployment configuration or the container image, by way of a signature. It is thereby protected against unauthorized modification. The signature may thus be validated by the runtime environment at deployment. It is possible to derive, from the at least one access authorization criterion, whether an alert message or stoppage of the execution of the second container instance to be protected should be initiated.

In embodiments, the method is computer-aided or computer-implemented or is carried out in computer-aided or computer-implemented fashion. The steps of embodiments of the method may be repeated as often as desired and repetitions may possibly be ended based on defined conditions, be these event-oriented or time-limited.

The monitoring function may be in the form of a reporting client for the container instances; this may be integrated on the device/host system (for example plug-in/agent) but also be run outside the host system on a remote system.

A further aspect of embodiments of the invention is a system suitable for handling at least one unauthorized access operation to at least one common resource by at least one first container instance, wherein the at least one first container instance and at least one second container instance are able to be executed on a common runtime environment of a host system, wherein the at least one second container instance uses the at least one common resource, comprising a provisioning unit and a monitoring unit, which are designed such that
the provisioning unit defines and provides at least one access authorization criterion for one of the second container instances that rules which operations involving accessing of the common resource by the at least one first container instance are authorized or unauthorized, and that
the monitoring unit checks when a new first container instance is launched, whether at least one access authorization criterion has been provided for the second container instance, and
in the event of a positive check, the monitoring unit monitors the operations of the first container instance during execution thereof as to whether these operations are unauthorized in accordance with the at least one access authorization criterion, and that
if, during monitoring, at least one operation is recognized as unauthorized, then an action that counteracts the accessing of the common resources is initiated by way of an alert message for the second container instance or by stopping the execution of the second container instance.

The monitoring unit may be in the form of a reporting client for the container instances; this may be integrated on the host system (for example plug-in/agent) but also be run outside the host system on a remote system.

The provisioning unit may likewise be integrated in a host system (for example plug-in/agent). A runtime configuration is given, for example by a deployment configuration made available by the provisioning unit and defined beforehand, for example by an app developer or app provider, for example start/stop container instances, by the runtime environment, possibly by updates, external tools for controlling access operations to the common resources by other container instances. The deployment configuration may also be defined in automated fashion using appropriate software tools and comprise, inter alia, default configurations, as they are known.

Use may also be made of a computer program product (non-transitory computer readable storage medium having instructions, which when executed by a processor, perform actions) comprising a non-volatile memory medium storing a loadable and executable program code that executes embodiments of the method according to one of the abovementioned embodiments in a processor unit in particular of one or, in distributed fashion, in multiple devices according to one of the embodiments described above.

Also claimed is a variant of the computer program product comprising program commands for configuring a creation device, for example a 3D printer, a computer system or a manufacturing machine suitable for creating processors and/or devices, wherein the creation device is configured by way of the programming commands such that the execution environment is able to be created.

In embodiments, the system and devices, units and computer program (products), which may comprise a loadable and executable program code or program code modules able to be loaded and executed in distributed fashion, may be designed in accordance with the developments/embodiments of the abovementioned method and the developments/embodiments thereof, and vice versa.

One embodiment of the invention makes provision for one or more units or components or apparatuses to be able to be integrated into embodiments of the system and for these to be able to be in the form of a software, firmware or hardware component. In embodiments, the system generally comprises at least one processor that is able to execute operations on the operating system level as a kernel.

A processor or processor unit may in particular be a central processing unit (CPU), a microprocessor or a microcontroller, for example an application-specific integrated circuit or a digital signal processor, possibly in combination with a storage unit for storing program commands, etc. A processor may also for example be an integrated circuit (IC) or a multi-chip module, in particular a field-programmable gate array (FPGA) or an application-specific integrated circuit (ASIC), a system-on-chip (SoC), a graphics processing unit (GPU), a processor for evaluating a neural network, such as for example a tensor processing unit (TPU) or a digital signal processor (DSP). The processor may have one or more computing cores (multicore). A processor may also be understood to be a virtualized processor or a soft CPU. It may also for example be a programmable processor that is furnished with configuration steps for executing embodiments of the method according to embodiments of the invention or is configured by way of configuration steps such that the programmable processor implements the features according to embodiments of the invention of the method or other aspects and sub-aspects of embodiments of the invention. The processor may have tamper-proofing for protection against physical manipulations, for example tamper sensors for detecting physical attacks.

### BRIEF DESCRIPTION

Some of the embodiments will be described in detail, with reference to the following figure, wherein like designations denote like members, wherein:

The figure (FIG) shows an exemplary arrangement in which embodiments of the method according to embodiments of the invention may be applied.

### DETAILED DESCRIPTION

The figure shows a host system H comprising a runtime environment L, which has a monitoring unit W and a provisioning unit B. Both units W and B may also be combined in one unit. At the operating system level, the runtime environment exchanges commands or instructions with a kernel K. The kernel ultimately controls operations. Prior to launching of a container instance I1 for an application, during the development of the application or app, which is able to be run in a container instance, for the application or for the container image A from which the container instance to be launched is generated using the runtime environment, a deployment configuration DK is defined. The deployment configuration, also called provisioning information, may also be defined by an app provider via an app store. The definition of a deployment configuration may also, depending on the app type, be generated automatically, possibly with standard values (default values). At least one access authorization criterion is additionally potentially defined during development or automatically (see above) and potentially provided by way of an app store or another download platform. The following variants of the at least one access authorization criterion are also possible in a combination of the variants. Deployment-based access rules ZD and/or image-based access rules ZA are provided for a container instance I1 to be protected. In the example, these access rules are loaded from a provisioning unit B in step 2. In step 1, the runtime environment L generates at least one resource R for the container instance I1 and the container instance I1 is also launched in step 3 and uses the generated at least one resource R. In step 4, a further container instance I2 is launched. Since the container instance I2, in step 5, performs operations on the resource R, called common resource, this container instance I2 needs to be monitored according to embodiments of the invention. The common resource may concern the namespaces respectively used by container instances and/or the namespace used by the host system and/or file system objects and/or device files. In the example, namespaces are used as a common resource. Embodiments of the invention may be applied in the same way to the file system object or device files.

Namespaces may be process namespaces, network namespaces or mount namespaces (mounting of files or directories). In the example, the host system has a process namespace HP, a network namespace HN and a mount namespace HM. In step 1, by way of example, the process namespace P, the network namespace N and the mount namespace M, which belong to the container instance I1, are generated by the runtime environment. These form the common resources R in the example.

In step 5, monitoring rules in the form of instructions are additionally transferred to the kernel K, these being able to be derived from the access rules provided that the monitoring unit W was monitoring, when the container instance I2 was launched, whether these access rules concern the container instance I1 that has already been launched. Such instructions may be provided to the kernel for example via eBPF programs (eBPF=extended Berkeley Packet https://ebpf.io/).

According to embodiments of the invention, for a container instance to be protected, I1 in the example, all operations of other container instances, I2 in the example, are monitored insofar as these operations concern their namespaces. If unauthorized or unpermitted access occurs in a namespace of the container instance to be monitored, the container instance is either stopped (terminated or interrupted) by the container runtime environment or informed thereby through an alert using an appropriate process signal on the init process, as it is known (see step 6 in the figure). An access rule in this regard defines which operations are permitted for other container instances in the namespace of the container instance to be monitored. It is also possible for a deny by default to be defined for all container instances. The permitted operations are usually system calls and may possibly also be expanded to capabilities or what are known as seccomp profiles (https://docs.docker.com/engine/security/seccomp), since the capabilities and seccomp profiles define a set of permitted system calls. It is likewise possible, in the same way as Falco mentioned at the outset, to carry out a check for corresponding system call parameters and thereby for example determine which object is referenced with embodiments of the system call (for example process ID, network interface or object in the file system).

The container instances I2 to be monitored are identified by checking which namespaces they share with the container instance I1 to be protected or are run in parent namespaces (for example the host process namespace HP) of the container instances to be monitored. The access rules are associated either with the image of the container instance to be protected or its deployment configuration. The container instances to be protected are referenced in the access rule by deployment or image labels or corresponding signatures assigned by the container runtime environment. The access rules likewise define which measures have to be performed in the event of contravention of the access policy. Measures may in this case be kill signals or other process signals to be applied to the init process of the container instance to be protected.

Permitted operations in a process namespace P and/or HP may for example be launching new processes, performing traces (tracking) or generally only reading the process namespace. In the mount namespace, exemplary embodiments would be reading the mount namespace, performing write operations or modifying mount points. In the network namespace, exemplary embodiments of permitted operations would be, in addition to reading the network namespace, modifying routes, opening new ports or for example activating firewall rules. When a container instance to be protected is launched, the container runtime environment or a monitoring unit W reads in the access rules associated with the container instance to be protected and loaded by the provisioning unit. The monitoring unit may monitor the operations of the container runtime environment as an extension of the runtime environment (for example as a plug-in) or alternatively as a separate server process (in the same way as Falco). In the case of the server variant, launch operations of containers on the runtime environment may be read by the kernel K, for example via eBPF programs or correspondingly provided modules. The runtime environment may also communicate the fact that a container instance to be protected is to be launched to the monitoring unit via appropriate interfaces. In the case of the server variant, the access rules are likewise read in at the latest when the container instance is launched.

The namespaces required for the container instance are then generated (see 1. in the figure). The container runtime environment is trusted. Only operations of other container instances to be monitored on the namespaces of the container instance to be protected are to be monitored, but not processes (for example system services) managed outside the container runtime environment.

Whether a container instance to be launched needs to be monitored depends on whether this shares the namespace directly with the container instance to be protected or is run in the parent namespace of the host system and whether corresponding access rules are defined and provided for the container instance to be protected.

A description will first be given of the case in which a container instance to be monitored shares one or more namespaces with the container instance to be protected: The monitoring unit integrated into the container runtime environment or the separate server process checks, when a new container instance is launched, whether this needs to be monitored by checking whether there is at least one access rule for this that needs to be applied based on assigned tags/labels or signatures and whether a namespace is shared with the container instance to be newly launched. If this is the case, the monitoring unit automatically generates eBPF programs or corresponding kernel queries using a module, these recording the init process of the container instance to be newly launched and all existing child processes and monitoring embodiments of the system calls and parameters that are relevant in accordance with the policy. If a new process is launched within the container instance to be monitored, this is likewise newly added and monitored by the same eBPF program. If contravention of at least one access rule is recognized, the result is reported back to the monitoring unit by the kernel. The monitoring unit, depending on the measure stored in the access rule, either performs stopping using a kill signal on the init process of the container instance to be protected or sends a corresponding alert-raising process signal thereto. In the latter case, the developer of the container image may themselves define how their application running in the container instance should behave. The container instance may thereby for example restart individual sub-processes or take certain functionalities out of operation until the scheduled restart of the application. It may also, for example, using a write operation to a persistent drive over the runtime, persist the non-permitted access of a container instance to be protected and thereby ensure, until a manual reset is carried out by the user, that the application in the container instance to be protected is offered with a reduced scope or no longer launches.

If container instances 12 to be monitored enter the parent namespace of the namespace to be protected, the operations to be monitored are determined in the same way as the method described above for the same namespace. In addition, however, further operations are also necessary: in the case of the process namespace, processes are able to be launched within the namespace to be protected only if the container to be monitored changes therein using setns (https://linux.die.net/man/2/setns) or is launched therein by the runtime environment using the deployment configuration. The processes running therein may however also be traced or stopped when the processes of the container instances I2 to be monitored in the parent space access same and are not changed in their namespace. In this regard, in the case of the process namespace, the monitoring unit needs to determine what process IDs the processes to be monitored of the container instance I1 to be protected have in the parent namespace. The same also applies to the mount namespace. In this case, the monitoring unit, when the container instance to be monitored is launched, has to monitor what the paths of the mount namespace in the superordinate host namespace are called and monitor the operations performed thereon. In the case of the network namespace, it is checked, in the superordinate parent node of the container to be monitored, whether changes are made within the network namespace by way of system calls, and these concern the assigned network namespace of the container to be protected.

By monitoring the container processes of the container instance to be monitored for individual namespaces, a developer of an application is also able to prevent sidecar containers from running transparent proxies on a cluster, these being run in the same network namespace as service meshes.

The at least one access rule may be integrity-protected, together with the deployment configuration or the container image, by a signature, and thereby be protected against unauthorized modification. For this purpose, the signature must be validated by the runtime environment at deployment.

The processes or method sequences described above may be implemented based on instructions present on computer-readable storage media or in volatile computer memories (referred to collectively below as computer-readable memories). Computer-readable memories are for example volatile memories such as caches, buffers or RAMs and non-volatile memories such as interchangeable data media, hard drives, etc.

The functions or steps described above may in this case be present in the form of at least one set of instructions in/on a computer-readable memory. The functions or steps are in this case not bound to a specific set of instructions or to a specific form of sets of instructions or to a specific memory medium or to a specific processor or to specific execution schemes and may be executed by software, firmware, microcode, hardware, processors, integrated circuits etc. operating on their own or in any combination. A wide variety of processing strategies may be used here, for example serial processing by a single processor or multiprocessing or multitasking or parallel processing, etc.

The instructions may be stored in local memories, but it is also possible to store the instructions on a remote system and to access this via a network.

The term “computer-aided” or “computer-implemented” may, in connection with embodiments of the invention, be understood for example to mean an implementation of the method in which in particular a processor, which may be part of a (control/computing) device or unit, executes at least one method step of the method. The method may in this case also be implemented in a computer cloud that is able to execute the method and is thus able to deliver results of the method to a control/computing device or unit, which is able to direct appropriate commands or measures to the devices, in particular those of the abovementioned arrangement.

Unless indicated otherwise in the following description, the terms “map”, “emulate”, “receive”, “apply”, “output”, “provide” and the like refer to actions and/or processes and/or processing steps that modify and/or generate data and/or convert the data into other data, wherein the data may be represented or be present in particular in the form of physical variables.

The term “processor”, “central signal processing”, “control unit” or “data evaluation means” encompasses processing means in the broadest sense, that is to say for example servers, universal processors, graphics processors, digital signal processors, application-specific integrated circuits (ASICs), programmable logic circuits such as FPGAs, discrete analog or digital circuits and any combinations thereof, including all other processing means known to a person skilled in the art or that will be developed in the future. Processors may in this case consist of one or more devices or apparatuses or units. If a processor consists of multiple devices, these may be designed or configured for the parallel or sequential processing or execution of instructions.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1-8. (canceled)

9. A computer-implemented method for handling at least one unauthorized access operation to at least one common resource by at least one first container instance, wherein the at least one first container instance and at least one second container instance are executed on a common runtime environment of a host system, wherein the at least one second container instance uses the at least one common resource, the method comprising:
defining and providing at least one access authorization criterion for one of the second container instances that rules which operations involving accessing of the at least one common resource by the at least one first container instance are authorized or unauthorized;
checking, when a new first container instance is launched, whether at least one access authorization criterion has been provided for the at least one second container instance;
in an event of a positive check, monitoring the operations of the at least one first container instance during execution thereof as to whether the operations are unauthorized in accordance with the at least one access authorization criterion,
wherein,
wherein, if, during monitoring, at least one operation is recognized as unauthorized, then initiating an action that counteracts the accessing of the at least one common resource, by way of an alert message for the at least one second container instance or by stopping the execution of the at least one second container instance,
wherein the at least one access authorization criterion is present in a container image belonging to the at least one second container instance.

10. The method as claimed in claim 9, wherein, in an event of a negative check, the operations of the at least one first container instance are monitored and, if, from a point of view of the runtime environment, all operations accessing the common resources are considered to be unauthorized, when such an operation considered to be unauthorized is executed, an action that counteracts the accessing of the at least one common resource is initiated by way of an alert message for the at least one second container instance or by stopping the execution of the at least one second container instance.

11. The method as claimed in claim 9, wherein the at least one common resource comprises namespaces respectively used by container instances and/or a namespace used by the host system and/or file system objects and/or device files.

12. The method as claimed in claim 9, wherein it is possible to derive, from the at least one access authorization criterion, whether an alert message or stoppage of the execution of the at least one second container instance should be initiated.

13. A system suitable for handling at least one unauthorized access operation to at least one common resource by at least one first container instance, wherein the at least one first container instance and at least one second container instance are able to be executed on a common runtime environment of a host system, wherein the at least one second container instance uses the at least one common resource, comprising a provisioning unit and a monitoring unit, which are configured such that:
the provisioning unit defines and provides at least one access authorization criterion for one of the second container instances that rules which operations involving accessing of the at least one common resource by the at least one first container instance are authorized or unauthorized, and that
the monitoring unit checks when a new first container instance is launched, whether at least one access authorization criterion has been provided for the at least one second container instance, and
in an event of a positive check, the monitoring unit monitors operations of the at least one first container instance during execution thereof as to whether the operations are unauthorized in accordance with the at least one access authorization criterion,
wherein, if, during monitoring, at least one operation is recognized as unauthorized, then an action that counteracts the accessing of the common resources is initiated by way of an alert message for the at least one second container instance or by stopping the execution of the at least one second container instance,
wherein the at least one access authorization criterion is present in a container image belonging to the at least one second container instance.

14. The system as claimed in claim 13, wherein, in an event of a negative check, the operations of the at least one first container instance are monitored and, if, from a point of view of the runtime environment, all operations accessing the common resources are considered to be unauthorized, when such an operation considered to be unauthorized is executed, an action that counteracts the accessing of the at least one common resource is initiated by way of an alert message for the at least one second container instance or by stopping the execution of the at least one second container instance.

15. A computer program product comprising a computer readable hardware storage device having computer readable program code stored therein, the program code executable by a processor of a computer system to implement a method as claimed in claim 9.
